(19) United States
(12) Patent Application Publication
(10) Pub. No.: US 2015/0026609 A1
(43) Pub. Date: Jan. 22, 2015

(54) IDEA WHEEL-BASED DATA CREATING APPARATUS

(71) Applicants: Ji Young KIM, (US); BOOGA VENTURES, INC., San Mateo, CA (US)

(72) Inventor: Ji Young Kim, Seongnam-si (KR)

(21) Appl. No.: 14/377,253

(22) PCT Filed: Feb. 4, 2013
(86) PCT No.: PCT/KR2013/000896

§ 371 Date: Aug. 7, 2014

(30) Foreign Application Priority Data
Feb. 7, 2012 (KR) 10-2012-0012272

(51) Int. Cl. G06F 3/0484; G06F 17/30

(52) U.S. Cl. CPC G06F 3/04842; G06F 17/30557
USPC 715/762

(57) ABSTRACT

An apparatus for creating idea wheel-based data is provided. In the apparatus, a DB management unit stores and manages data. A Visual Basic Application (VBA) unit reads the data stored in the DB management unit and creates as an idea wheel a user interface (UI) including a home as a reference position and wheels formed to surround the home. A logical structure unit sets an X and Y coordinate for the idea wheel, divides the idea wheel into sectors having the set X and Y coordinate as a reference, and arranges the data by a cell unit in each wheel included in the sector. A wheel controller controls the idea wheel enabling a user to edit the idea wheel indicated by the UI for each sector, each wheel or each cell.

### BACKGROUND

The present disclosure relates to an apparatus for creating idea wheel-based data, which is capable of creating, managing and controlling data using at least one wheel.

Typically, various application programs and systems manage data in a tree structure, namely, in a scheme that an upper theme is arranged on an upper end portion, and a subordinate theme is arranged on a lower end portion. Here, the tree structure scheme may be a structure that one category is enlarged like branches of tree to be connected to a plurality of objects of subordinate concepts.

A representative example using this tree structure scheme is a spreadsheet. The spreadsheet is an application program like Microsoft® Excel, which is executed by a processor.

The spreadsheet includes individual cells formed by multiple rows and columns.

Users may arrange numbers and text data in cells of the spreadsheet as desired using a graphic user interface of a computer, and designate formats of the numbers and the text data so that they are recognized as one of various kinds of data including text, data, and money.

Like this, in order to enable beginners and intermediate users to prepare a worksheet using the spreadsheet, application providers provide the users with templates having commonly used functions such as financial projection, checkbook sheets, and expense reports.

However, the spreadsheet neglects a first upper object and intermediate consecutive objects, and recognizes only the last object, since the spreadsheet performs operations in a tree structure scheme to infer a final conclusion.

Due to this, users may not see the flow from the upper object to the lower object at a glance. Therefore, there are many cases that the user goes back to the beginning and searches the first upper object several times.

Even though there have been efforts to find another data management scheme besides the tree structure scheme, a new data management scheme is still under development.

### SUMMARY

Embodiments provide an apparatus and method of continuing to manage, control, and create data, and forming data objects consistently.

Embodiments also provide a method of managing and creating data, which is easily extended to various application programs.

In an embodiment, an apparatus for creating idea wheel-based data includes: a database (DB) management unit storing and managing data; a Visual Basic Application (VBA) unit for reading the data stored in the DB management unit and creating as an idea wheel a user interface (UI) including a home as a reference position and wheels formed to surround the home; a logical structure unit setting an X and Y coordinate for the idea wheel, dividing the idea wheel into sectors having the set X and Y coordinate as a reference, and arranging the data by a cell unit in each wheel included in the sector; and a wheel controller controlling the idea wheel enabling a user to edit the idea wheel indicated by the UI for each sector, each wheel or each cell.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating components of an apparatus for creating idea wheel-based data, according to the embodiment.

FIG. 2A is a view illustrating a configuration of a visual basic application (VBA) unit, according to the embodiment.

FIG. 3 is a view illustrating a configuration of an image piece distributor, according to the embodiment.

FIG. 4 is a view illustrating a configuration of a logical structure unit, according to the embodiment;

FIG. 5 is a view illustrating a configuration of a wheel controller, according to the embodiment;

FIG. 6 is a view illustrating an idea wheel logical structure created through the logical structure unit, according to the embodiment;

FIG. 7 is a view illustrating a configuration of an idea wheel creating unit, according to the embodiment;

FIG. 8 is a view illustrating a configuration of an idea flat creating unit, according to the embodiment;

FIG. 9 is view illustrating a configuration of a file management unit, according to the embodiment;

FIG. 10 is a view illustrating a configuration of an edit management unit, according to the embodiment;

FIG. 11 is a view illustrating a configuration of a view management unit, according to the embodiment;

FIG. 12 is a view illustrating an activation of IW OUTLINE view in the view management unit, according to the embodiment;

FIG. 13 is a view illustrating a configuration of an idea wheel modification unit, according to the embodiment;

FIG. 14 is a view illustrating a function of drill in/out, according to the embodiment;

FIG. 15 is a view illustrating a function of zooming in, according to the embodiment;

FIG. 16 is a view illustrating a function of zooming out, according to the embodiment;

FIG. 17 is a view illustrating a function of sheet insertion, according to the embodiment;

FIG. 18 is a view illustrating a configuration of an insert management unit, according to the embodiment;

FIG. 19 is a view illustrating a configuration of a tool management unit, according to the embodiment;

FIG. 20 is a view illustrating a configuration of an education management unit, according to the embodiment;

FIG. 21 is a view illustrating a configuration of a window management unit, according to the embodiment;

FIG. 22 is a view illustrating a function of image piece distributor, according to the embodiment;

FIG. 23 is a view illustrating a function of a dialing unit, according to the embodiment;

FIG. 24 is a view illustrating a function of opening a new idea wheel among education management functions, according to the embodiment;

FIGS. 25 to 27 are views illustrating a menu screen related to functions of education and management, according to the embodiment;

FIGS. 28 to 30 are views illustrating performing of functions of education and games using an idea wheel, according to the embodiment; and

FIG. 31 is a view illustrating a flow chart of a method of creating data objects having an idea wheel logical structure, according to the embodiment.

### DETAILED DESCRIPTION OF THE EMBODIMENTS

Reference will now be made in detail to the embodiments of the embodiment, examples of which are illustrated in the accompanying drawings.

Prior to describing various embodiments of the present invention with reference to the accompanying drawings, the terms used for describing configurations and operations of the present invention are first defined. However, the definition of the terms is intended to help the readers understand the present disclosure and the scope of a right of the present disclosure is not limited thereto.

Data Object: It indicates information that stores a value containing a variable or an array in a specific region, and its examples include texts, music, images, videos and content of their files or folders.

Idea Wheel: It is a user interface (UI) enabling generation, management and control of the data object and includes a plurality of concentric circles, each of circles with different radii each becomes a wheel, and the idea wheel indicates a UI including at least one wheel.

Cell: It is a unit of a storage of the idea wheel in which data objects are stored, cells are grouped to make rows and columns, and the same row of cells make one wheel.

Sector: It is a unit dividing the idea wheel, which may be divided into four sectors by the X axis and the Y axis if the idea wheel is displayed by an X and Y coordinate system. A user may set or edit the number of sectors and cells present in different wheels may be included in one sector.

Home Portion or Home: It is a region including the center of the idea wheel, keeps the top level object of data to be managed through the idea wheel, and may also be a UI through which a user may select movement to the previous step, depending on the situation.

Idea Flat: It is a UI enabling generation, management and control of the data object and has a structure where a master is arranged on the higher side and a slave is arranged on the lower side while the idea wheel is a circular UI. A user may set/select alignment and arrangement of data with the idea wheel or the idea flat.

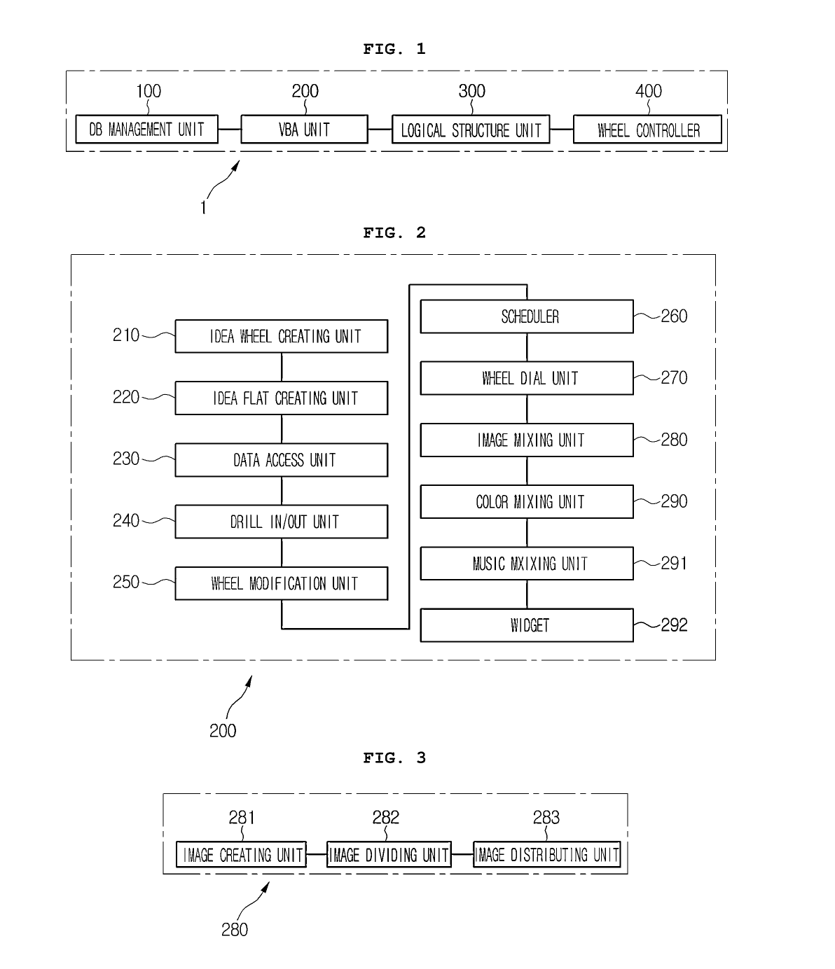

FIG. 1 is a view illustrating a configuration of an idea wheel-based data creating apparatus.

Although the title of the present disclosure is an apparatus for creating idea wheel-based data, the present disclosure includes not only data creation, but also various controls such as data editing and data controls.

An apparatus according to the embodiment includes a DB management unit 100, a visual basic application (VBA) unit 200, a logical structure unit 300 and a wheel controller 400.

The DB management unit 100 stores program codes for creating or editing a logical structure of an idea wheel, stores data regarding contents such as pictures, texts, videos or files, and performs management of those data.

The VBA unit 200 reads the program codes and the data from the DB management unit 100, creates an idea wheel logical structure as a user interface under a control by the wheel controller 400, and causes the idea wheel logical structure to be created/edited/displaced/wheel-rotated according to the user's purpose.

The logical structure unit 300 forms a plurality of circle type wheels to be separated from each other around an origin in a coordinate with X and Y axes, forms fan-shaped sectors in the coordinate, and arranges data by a cell unit in each wheel.

The wheel controller 400 accesses to the data sequentially along the radial direction from a home (a region including a center of concentric circles) of the idea wheel, sets data included in the home (or home portion) as a master, and sets data included in the wheel surrounding the home as a slave. The wheel controller 400 displays on a display the home and the idea wheel having at least one or more of wheels, in order for a user to see a logical structure of the idea wheel at a glance. And the wheel controller enables creation/editing/displacement/wheel-rotation of the logical structure of the idea wheel based on event values set in the data, and the user's input (touch or click).

Hereinafter, the DB management unit 100, the VBA unit 200, the logical structure unit 300 and the wheel controller 400 will be described in detail.

DB Management Unit

The DB management unit 100 includes MySQL, and MySQL is a multi-user and multi-thread structured query language (SQL) database server including mysqld which is a DB server daemon, and data libraries regarding program codes, pictures, texts, videos, or files.

In addition, when the apparatus and method of the embodiments are implemented for educational applications, the DB management unit 100 may store data for various kinds of dictionaries, and data for native's pronunciation, voice, chemical symbols, countries and capitals thereof, countries and national flags thereof. Accordingly, when the preset disclosure is adopted as an operating system (OS) of a system such as a PC or a smartphone, the DB management unit 100 may store data for driving the system. When the embodiment is employed to applications such as language learning, news, or shopping, the DB management unit 100 may store data regarding corresponding applications.

VBA Unit

The VBA unit 200, as described above, forms a UI for showing the data stored in the idea wheel to users, and functions thereof may be varied according to a kind of software to which the apparatus and method of the embodiments are applied, and uses of the applications.

For the VBA unit 200, examples of a kind of software to which the apparatus and method of the embodiments are applied, and functions thereof will be described. However, the items illustrated in drawings are described mainly for showing various embodiments, and each component is not necessarily included.

The VBA unit 200 may include an idea wheel creating unit 210, an idea flat creating unit 220, a data access unit 230, a drill in/out unit 240, a wheel modification unit 250, a scheduler 260, a wheel dial unit 270, an image mixing unit 280, a color mixing unit 290, a music mixing unit 295 and a widget 295a. In practice, in an aspect of hardware, since one or the small number of application processors may be employed, it is not necessary for each component to be implemented as a separate device.

Accordingly, functions of the embodiment are needed to be understood.

1. Idea Wheel Creating Unit 210

The idea wheel creating unit 210 sets a title of the idea wheel logical structure, a value of a sector counter, a value of a wheel counter, and a value of a column counter in a sector. In addition, the idea wheel creating unit 210 generates a discus-shaped idea wheel which enlarges a discus-shaped wheel along a radial direction from an origin on a sheet screen, on a main frame of the sheet screen by using the user's interface (UI).

The user may set a title of the wheel logical structure (which is to be described in home), the number of sectors, or the ranks within a sector, by using software (application).

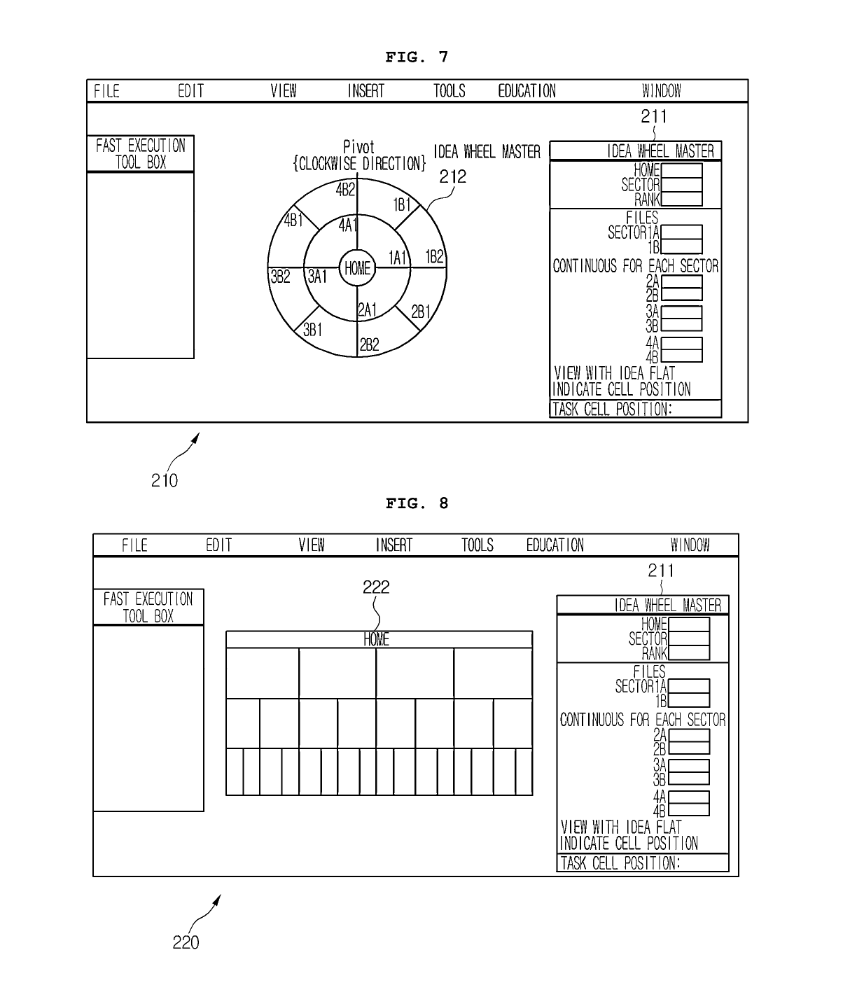

For example, as described in FIG. 7, the user may write content or the number of sectors and idea wheels to each item provided from the idea wheel master 211. Based on the written items in the idea wheel master 211, the idea wheel UI 212 may be created. In FIG. 7, an idea wheel UI 212 is shown where HOME is written to the home portion, the number of sectors is written to be 4, and the number of wheels is written to be 2.

That is, the idea wheel master 211 activates an input frame on the sheet screen for setting the title of the idea wheel logical structure, a counter value of sectors, a counter value of the wheels, and a rank within the sector.

2. Idea Flat Creating Unit 220

The user may not only directly create an idea wheel by using the idea wheel creating unit 210, but the user may also create an idea flat able to be modified to an idea wheel.

When the user sets the title of the idea wheel logical structure, the number of the sectors, the number of wheels, and the rank within the sector, the idea flat creating unit 220 creates an idea flat which is extended on the sheet screen from an upper end portion thereof toward a lower end portion in a deployed plane type wheel based on the set values through the UI.

For example, as illustrated in FIG. 8, the idea flat creating unit 220 includes the idea flat master 221 and an idea flat UI 222.

The user writes content, or the number of sectors and idea wheels to each item provided from the idea flat master 221. Based on the idea flat master 221, an idea flat UI 222 is created.

That is, the idea flat master 221 activates an input frame for setting the title of the idea flat type logical structure, the number of sectors, the number of the wheels, and a rank within the sector.

Meanwhile, the user may select a UI to be created in an idea wheel type or an idea flat type. In particular, since a structure of a master and input items are the same for creating an idea wheel and an idea flat, it is easy to convert the idea wheel into the idea flat, and vice versa.

3. Data Access Unit 230

The data access unit 230 sets an upper object of the data to the home portion, an intermediate object to a first wheel, and a subordinate object of the data to a second wheel. In addition, from the origin toward an outer side wheel, or from the upper end portion toward the lower end portion, the data access unit 230 recognizes data objects to get more concretized, and accesses to each of them.

The data access unit 230 accessed to data objects including icons, folders, texts or images, which are included in the home portion, the sectors, and the wheels.

4. Drill in/Out Unit 240

The drill in/out unit 240 separates and enlarges specific sectors or specific wheels according to the user's input. When the present disclosure is implemented in a PC, and the user selects specific sectors by manipulating a keyboard or a mouse, the corresponding sectors are separated and enlarged. When the present disclosure is implemented in a device with a touch screen, specific sectors selected by the user's touch (form example, a multi-touch) may be separated and enlarged.

The drill in/out unit 240 extracts the same portion selected in specific sectors from a selected wheel and all the subordinate objects in cells included in the selected wheel, creates the same portion on a new sheet screen, or synthesizes the same portion with the existing ideal wheel logical structure.

That is, when the user selects specific sectors, the specific sectors get separated and enlarged to a new idea wheel, which may be called drill out. While drill in indicates that the separated and enlarged sectors are recovered to the original idea wheel.

The drill out, as shown in FIG. 14, extracts a wheel included in a sector selected from the idea wheel, and each cell included in the wheel.

On the contrary, the drill in displaces a specific portion wheel extracted by the drill out and the subordinate objects of the cells included in the specific portion wheel to an idea wheel of a new sheet screen, inserts/synthesizes the same to/with the idea wheel.

5. Wheel Modification Unit 250

As described above, when the user requests conversion from the idea wheel to the idea flat or vise versa, the wheel modification unit 250 changes a UI as requested.

That is, the wheel modification unit 250 performs one-to-one displacement for the home portion, the wheels, the sectors, the rows, and the columns in the idea wheel creating unit 210 to the idea flat creating unit 220 to be displayed, or for the home portion, the wheels, the sectors, the rows, and the columns in the idea flat creating unit 220 to the idea wheel creating unit 210 to be displayed.

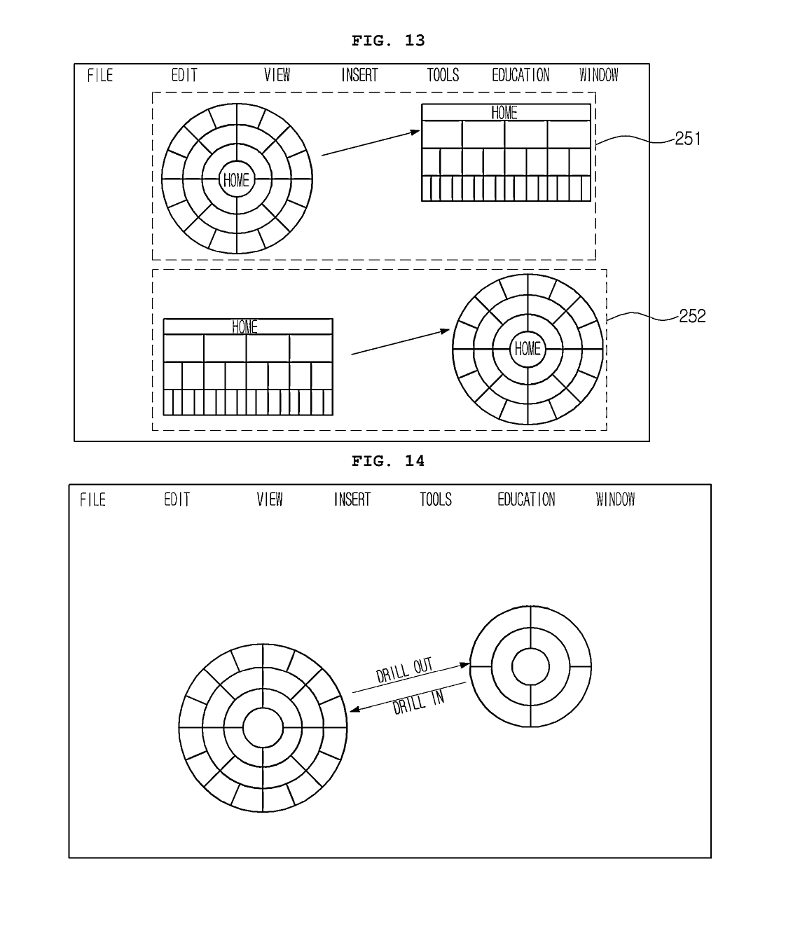

The user may want to see the content through a circle type idea wheel, or a tile type idea flat depending on a type of the content. This kind of UI modification is realizable. FIG. 13 illustrates a conversion 251 from a wheel structure to a flat structure, and a conversion 252 from a flat structure to a flat structure.

6. Scheduler 260

The apparatus and method of the embodiments may be used as software for recording a schedule to manage the same in a user's computer or a user's smartphone, making a memo or writing a diary.

Components described herein are not always necessary to be fully prepared.

The scheduler 260 records and generates a schedule or a plan for each week or for each day in the home portion, the wheels, or the sectors of the idea wheel and the idea flat, and makes the user know events set on a specific date by sending an alarm, vibration or an SMS to the use's smartphone.

This may be achieved by activating on a sheet screen an input frame through which a schedule or a plan is written for each week or for each day to the home portion, the wheels, or the sectors.

The scheduler 260 outputs the alarm, vibration or an SMS to the smartphone according to the events set to the data objects under a control by a smartphone associating unit (not shown) of the wheel controller 400.

7. Wheel Dial Unit 270

When the embodiment is implemented as software for a phone call, the wheel dial unit 270 enables a user to input or search a phone number by using UI of the idea wheel.

The wheel dial unit 270 may rotate each wheel in a clockwise direction or in a counterclockwise direction by each row or a sector with a pivot unit (see 310 in FIG. 6, a virtual line being a center of the wheel rotation) being a reference rotation direction, and displace positions of the data objects.

In order to achieving the phone call function, each sector, each wheel, or each cell may be indicated with numbers or alphabets. The user may use the phone call function for making a call, searching phone numbers or registering phone numbers by rotating or selecting the sectors, the wheels and the cells.

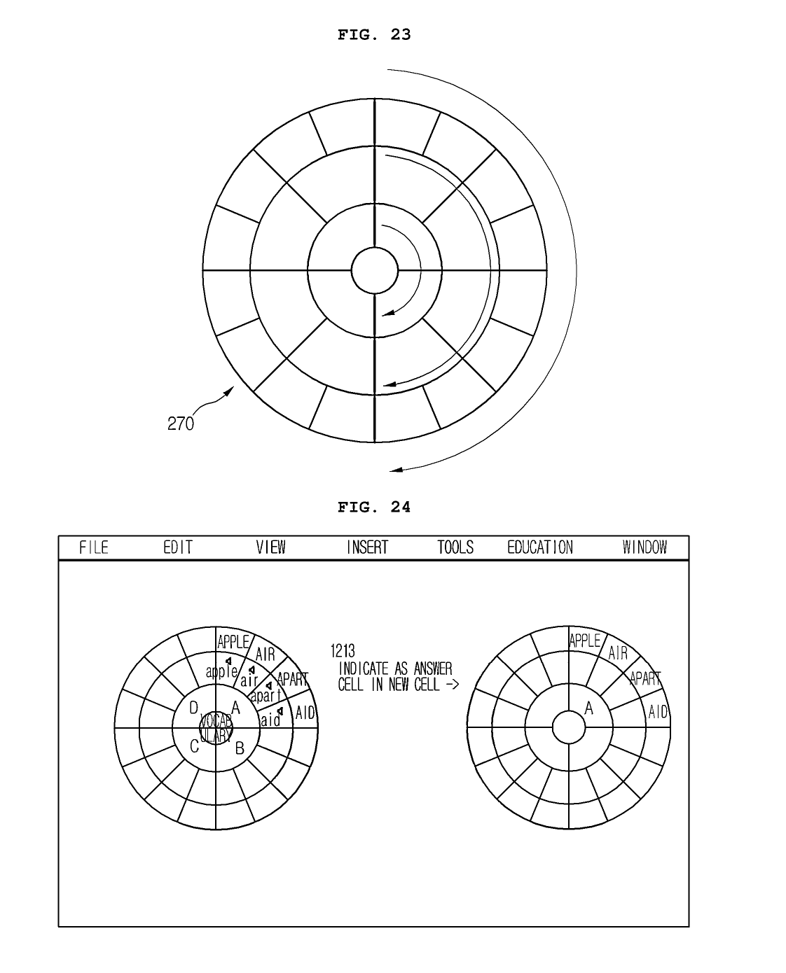

For example, as shown in FIG. 23, when the wheel is rotated for each row or each sector, the wheel may be rotated as a dial of the phone.

8. Image Mixing Unit 280

When the embodiment is implemented as software for security, for example, the user does not want to show a certain file (for example, an image) on a screen, the file (or the image) may be stored in an idea wheel type. Since a typical image corresponds to an idea flat of the embodiment, the image may be different from an original image when the image is modified in the idea wheel structure.

This function may be performed by the image mixing unit 280.

The image mixing unit 280, as shown in FIG. 22, sequentially divides an image created as an idea flat into a home portion, wheels, and cells, and rearranges the divided image pieces to a home portion, wheels, and cells of an idea wheel structure in order to have a one-to-one correspondence.

In this view, the image mixing unit 280 may include an image creating unit 281, an image dividing unit 282 and an image distributing unit 283.

The image creating unit 281 creates a specific image in an idea flat structure.

The image dividing unit 282 divides the image created in the idea flat structure into a home portion, wheels, and cells.

The image distributing unit 283 distributes the divided image and associates the same with the home portion, the wheels, and the cells in the idea wheel structure, and displays the associated results.

Even though the image is exemplified, when only a specific user (a manager) is allowed to recover an original state (for example, an image of an idea flat structure), the image mixing unit 280 is highly recommended in these days when the security is very important.

9. Color Mixing Unit 290

In the above, an image is exemplified for applicability to a program regarding security. In the same idea, when colors are mixed and modified to an idea wheel structure, the color mixing may be also used for a security program that only a specific user can confirm an original color.

In addition, an idea flat structure image is divided into sectors, wheels and cells, and stored information on each color as the ideal wheel structure, the color mixing may be applied to an educational program such as picture drawing.

In this aspect, the color mixing unit 290 may set colors for each wheel and each cell of the idea wheel structure, mix the colors by rotating the set wheels or cells, store the mixed colors to the DB management unit 100, or send the same to an external medium.

10. Music Mixing Unit 291

The present disclosure may be also implemented as a music-related program for composing music, or editing a music file.

In this aspect, the music mixing unit 291 may set music for each wheel, and each cell of the idea wheel structure, mix the music by rotating the set wheels or cells, store the mixed music to the DB management unit 100, or send the same to an external medium.

11. Widget Unit 292

The embodiment may be used for a program for forming and managing a widget in a desktop computer, a notebook computer, a smartphone or a tablet PC.

In this aspect, the widget unit 292 forms an idea wheel as a UI without using a web browser in a PC, a mobile phone, a blog, or an internet community to cause a widget of an idea wheel structure to be formed. For example, the user may confirm weather in other areas, or stock quotations in real time while moving the wheel

In addition, the widget may be implemented as a widget of an idea wheel structure, a scheduler widget of an idea wheel structure, a phone dial widget, an image piece distributing widget, a color mixing widget, or a music mixing widget, depending on an installation environment.

Logical Structure Unit

The logical structure unit 300 creates multiple circle type wheels around an origin in a coordinate with X and Y axes, creates fan shaped sectors in the X and Y coordinate, and arranges data to each wheel for each cell.

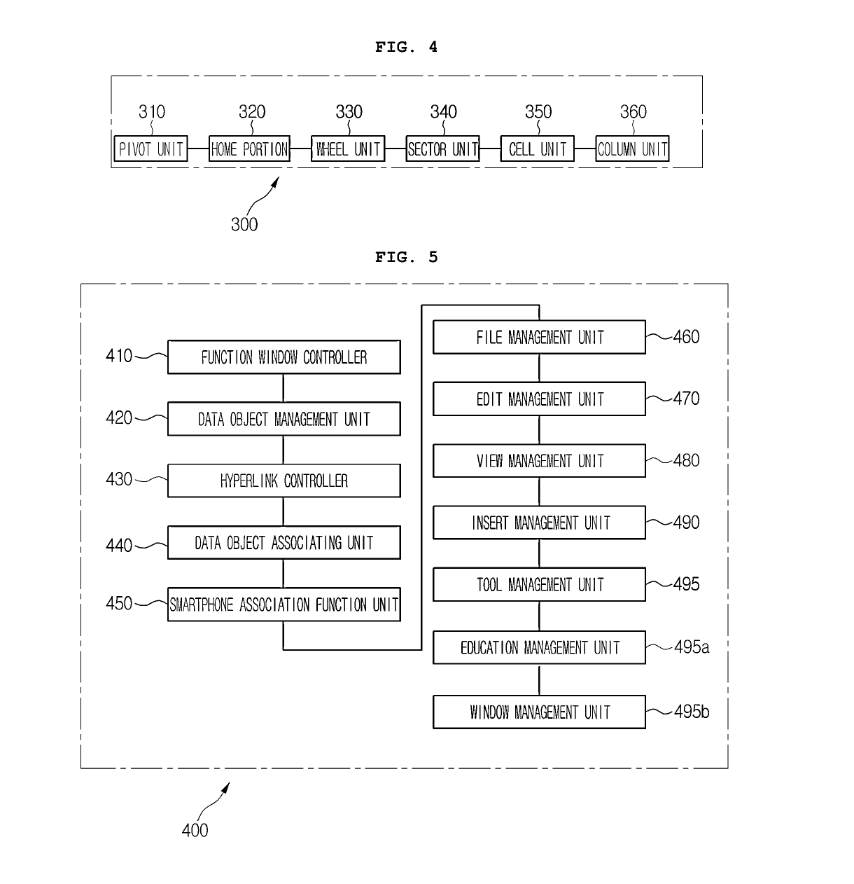

The logical structure unit 300 includes, as shown in FIGS. 4 and 6, a pivot unit 310, a home portion 320, a wheel unit 330, a sector unit 340, a cell unit 350, and a column unit 360. As described above, each component 310,320,330,340,350 or 360 forming the logical structure unit 300 is used for discriminating a configuration of the UI, but they are not necessarily implemented as physically separated hardware.

The smallest unit for forming an ideal wheel UI may be a cell 350, cells within a distance of the same radius may form a wheel, cells arranged in the same direction form a column, and an area separated by the pivot 310 becomes a sector.

In FIG. 6, an example where multiple cells, 3 wheels, and 4 columns are formed in a first sector 341, which is separated by the pivot 310, is illustrated. As a master area of an idea wheel, a first wheel, a second wheel, and a third wheel are sequentially formed around the home portion 320 which is formed at a center of the circle.

The pivot 310 may separate the idea wheel into at least 2 or more areas using the X and Y coordinate. The sectors may be also separated by the pivot 310. FIG. 6 illustrates the case where 4 sectors are formed. The wheel and the column in the first sector 341 will be described.

In the first sector 341, a first wheel includes a first cell 351, a second wheel includes a second cell to a fifth cell 352,353,354, and 355, a third wheel includes a sixth cell to a ninth cell 356,357,358, and 359.

As this, in the idea wheel, the wheel is a set of cells being in the same distance from the home portion 320.

In addition, in the first sector 341, a first column 361 includes the fifth cell 355 and the ninth cell 359, a second column 362 includes the fourth cell 354 and the eighth cell 358, and a third column 363 includes the second cell 352 and the sixth cell 356.

Even though each component forming the idea wheel is described mainly on the cells, a shape of the idea wheel and classification of the components may be more variously changed.

Hereinafter the home, the cells, the wheels, the columns, and the sectors which may be separated by the logical structure unit 300 will be described in detail.

The pivot 310 plays a role of setting a central axis of rotational direction with X axis and Y axis crossed perpendicularly at the origin. This means any one of X axis, −X axis, Y axis, and −Y axis is selected to be a central axis. Here, the central axis indicates a reference axis of rotational direction.

The home (or home portion) 320 shows a name of an item of the master at the origin. The home 320 is the master including a parent folder and parent files.

The wheel 330 plays a role of setting a rank which is an indication object of a data object of a cell unit with the discus shape thereof enlarged toward an outer side from the home 320.

The wheel may include a 1a wheel having a first discus shape with an origin of the home 320 as a reference, a 2a wheel having a second discus shape and being in an outer side of the 1a wheel, a 3a wheel having a third discus shape and being in an outer side of the 2a wheel, and a 4a wheel having a fourth discuss shape and being in an outer side of the 3a wheel.

In addition, the wheel 330 may include a 1b wheel having a first discus shape with an origin of the home 320 as a reference, a 2b wheel having a second discus shape in a lower end side of the 1b wheel, a 3b wheel having a third discus shape in a lower end side of the 2b wheel, and a 4b wheel having a fourth discus shape in a lower end side of the 3b wheel.

The wheel 330 may be created in plural according to wheel counter values of the idea wheel creating unit 210 and idea flat creating unit 220.

The sector 340 may be formed in a fan shape and interposed between X axis and Y axis. A plurality of data objects included in the fan shape portion are grouped into a sector, which is an indication object of a cell unit. The sector 340 creates an auxiliary sector reference line of a straight line in the wheel 330.

The sector 340 includes a 1a sector having a fan shape and being interposed between X axis and Y axis, a 2a sector having a fan shape and being interposed between X axis and −Y axis, a 3a sector having a fan shape and being interposed between −X axis and −Y axis, and a 4a sector having a fan shape and being interposed between −X axis and Y axis.

In addition, the sector 340 includes a 1b sector having a first flat shape in an idea flat, a 2b sector having a second flat shape in a lateral direction of the 1b sector, a 3b sector having a third flat shape in a lateral direction of the 2b sector, and a 4b sector having a forth flat shape in a lateral direction of the 3b sector.

The sector 340 according to the embodiment is formed in plural according to counter values of the idea wheel creating unit 210 and idea flat creating unit 220.

The cell 350 is a unit object of a data object formed by the wheel 330 and the auxiliary sector reference line crossing with each other.

The user may make a memo to each cell 350, write a schedule, and store images and files in a drag and drop type. Location information of the idea wheel creating unit 210 and idea flat creating unit 220 is indicated by rows and columns.

The column is an indication object of a data object of a cell unit, when the cell 350 is rotated around a central axis in a clockwise direction or in a counterclockwise direction.

For example, when two cells are in the 3a wheel of the 1a sector around the central axis in the idea wheel, a cell positioned first around the central axis is a first column, and a consecutive second cell is a second column.

Like this, the logical structure unit 300 according to the embodiment may create an idea wheel with the pivot 310, the home 320, the wheel 330, the sector 340, the cell 350 and the column 360. Since the embodiment may create an idea wheel logical structure having an idea wheel and an idea flat, there is no limit on idea wheel enlargement due to a structure thereof having continuity and consistency. Therefore a data object included in a home portion, sectors and wheels of an idea wheel and an idea flat may be formed continuously and consistently.

Wheel Controller

Hereinafter, the wheel controller 400 will be described.

The wheel controller 400 accesses data from a wheel at an origin of the logical structure unit 300 to a wheel in an outer circumferential direction, sets data included in the wheel at the origin as a master, and sets data included in the wheel in the outer circumferential direction as a slave.

The wheel controller 400 also controls the logical structure unit 300 of the ideal wheel to be displayed on a screen in order to be seen at a glance, and performs a control action mode according to event values set in the data to control the idea wheel logical structure to be created, edited, displaced and wheel-rotated.

As described above, the wheel controller 400 is not necessarily implemented with a separate physical device from other components. Here, functions of the wheel controller 400 for creating an idea wheel/flat of the embodiment, and managing data are described. Additional functions which are not illustrated in drawings may be further implemented, and here, several examples will be described.

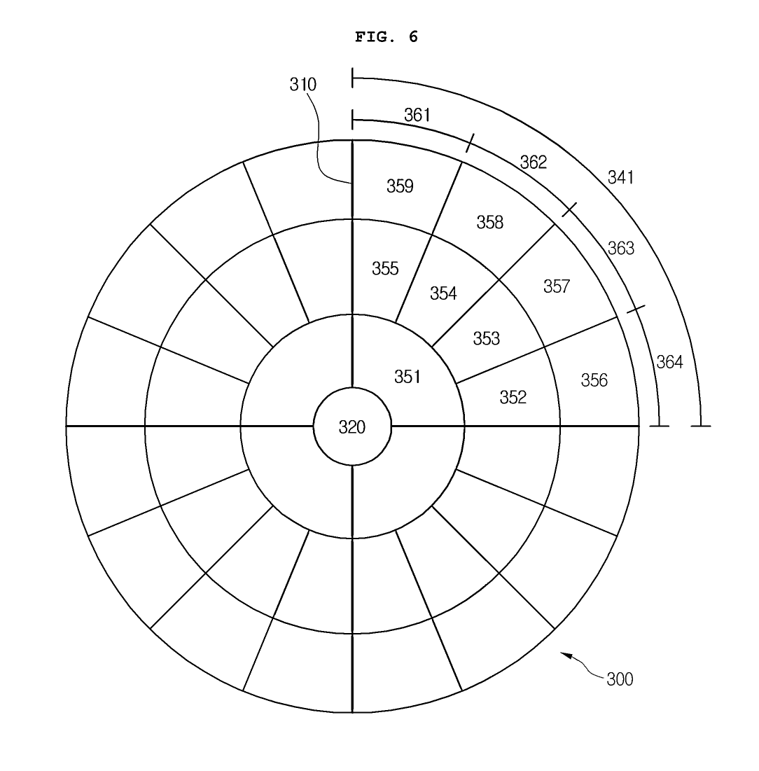

As illustrated in FIG. 5, the wheel controller 400 may perform functions of a function window controller 410, a data object management unit 420, a file management unit 460, a edit management unit 470, a view management unit 480, an insert management unit 490, a tool management unit 495, an education management unit 495a and a window management unit 495b.

First, the function window control function will be described.

The function window controller 410 creates/manages various input windows in order for the user to create an idea wheel or an idea flat. That is, in a state where a table or a window is positioned on any of upper ends and lateral sides of a main frame and an auxiliary frame, and the idea wheel or the idea flat is activated by default, the function window controller 410 activates a file window, an edit window, a view window, an insert window, a tool window, an education window, and other windows.

The function window controller 410 controls components, an activation order, and sub directories to be activated of a file window, an edit window, a view window, an insert window, a tool window, an education window, and other windows in associated with the file management unit 460, the edit management unit 470, the view management unit 480, the insert management unit 490, the tool management unit 495, the education management unit 495a and the window management unit 495b.

The function window controller 410 displays a main frame and an auxiliary frame on a sheet screen in order for the user to create or edit an idea flat/wheel.

Second, the data object managing function will be described.

The data object management unit 420 adds, amends, or deletes a data object in a sheet screen including an idea wheel or an idea flat.

Here, the data object includes all kinds of data that a user desires to store or manage, including a text, music, sound, an image, a video, a file, a folder and content.

Third, the hyperlink control function will be described.

A hyperlink controller 430 sets up hyperlinks for data objects including wheels, sectors, and cells of an idea wheel and an idea flat to internet sites and application programs to be accessed.

Fourth, a data object association function will be described.

A data object associating unit 440 reads specific objects from the hyperlinked internet site and application program through the hyperlink controller 430 and stores the same to DB management unit 100, and outputs data objects stored in the DB management unit 100 to the internet site and the application program.

Fifth, a smartphone association function will be described.

A smartphone association function will be described.

The smartphone association function unit 450 is connected to a smartphone, and controls an alarm, vibration, or an SMS to be output to the smartphone according to events set to a data object.

In addition, the smartphone association function unit 450 finds a position of the smartphone by interworking with a position tracking system and a global positioning system (GPS) provided by an external internet site, and then controls an alarm, vibration, or an SMS to be output to the corresponding smartphone according to events set to a data object. A logical structure of an idea wheel of the embodiment may be implemented as an OS of a smartphone or a tablet PC, or operated as an application to those devices.

Sixth, the file managing function will be described.

The file management unit 460 enables Open/Close/Save/Print functions for a file or folder included in an idea wheel or an idea flat, and reads a specific data object from an internet site and an application program through the data object associating unit 440 to synthesize the same with data objects of the idea wheel/flat. The file management unit 460 manages to output data objects of an idea wheel/an idea flat stored in the DB management unit 100 to the internet site and the application program.

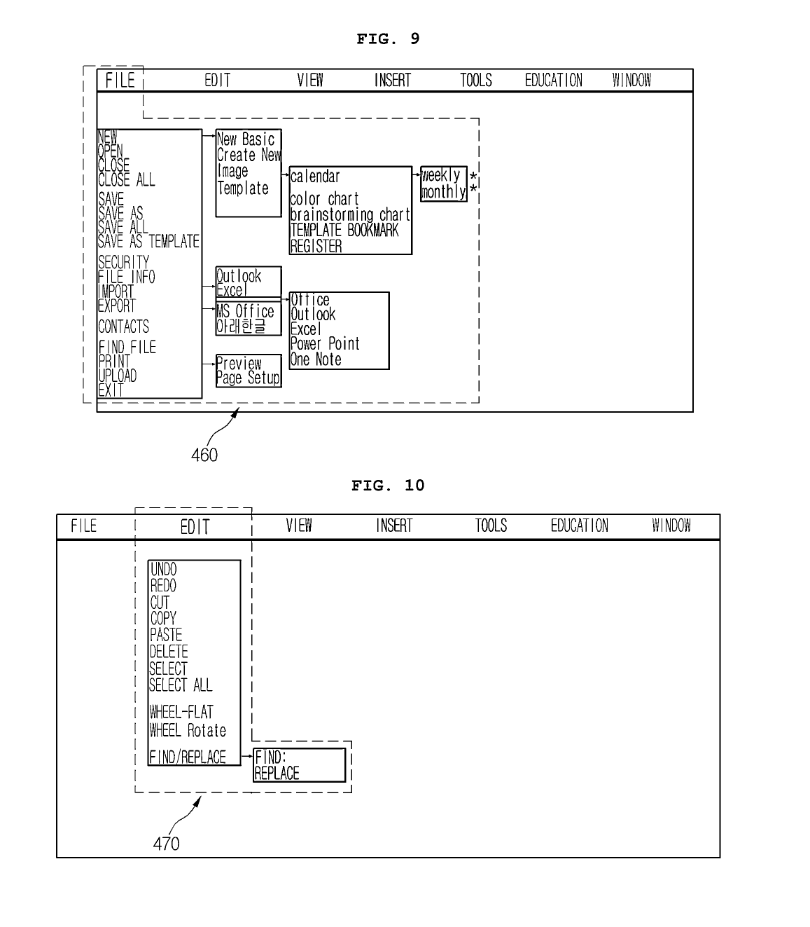

Due to this, as shown in FIG. 9, an activation window is formed including NEW (for a new idea wheel/flat), OPEN, CLOSE, CLOSEALL, SAVE, SAVE AS, SAVE ALL, SAVE AS TEMPLATE, SECURITY, FILE INFO, IMPORT, EXPORT, CONTACTS, FIND FILE, PRINT, UPLOAD, and EXIT menu.

‘NEW’ creates a new logical structure including an idea wheel or an idea flat on a sheet screen.

‘OPEN’ opens and confirms an idea wheel or an idea flat stored in advance on a sheet screen.

‘CLOSE’ closes and deactivates a portion of an idea wheel or an idea flat activated on a sheet screen.

‘CLOSEALL’ closes and deactivates an entire idea wheel or an entire idea flat activated on a sheet screen.

‘SAVE’ stores an idea wheel or an idea flat activated on a sheet screen.

‘SAVE AS’ stores an idea wheel or an idea flat activated on a sheet screen with another name.

‘SAVE AS TEMPLATE’ stores a template of a data object included in a home, sectors, wheels, or cells of an idea wheel or an idea flat activated on sheet screen.

‘SECURITY’ sets activation to be enabled only by a user inputting a password due to decryption for an idea wheel or an idea flat.

‘FILE INFO’ displays information on data objects included in a home, sectors, wheels, and cells of an idea wheel or an idea flat activated on sheet screen. Here, the information on the data object may include all information on a text, music, a sound, an image, a video, a file, a folder, and content.

‘IMPORT’ reads a specific data object from an internet site and an application program through the data object associating unit 440, and synthesizes the same with data objects of an idea wheel or an idea flat.

‘EXPORT’ outputs data objects of an idea wheel or an idea flat stored in the DB management unit 100 to an internet site or application programs including Outlook, Excel, PowerPoint.

‘CONTACTS’, as shown in FIG. 9, creates an address list by interworking with Outlook Express, or an email account. This enables to efficiently manage an address list of a player (a performer) and an address list of friends.

‘FIND FILE’ finds data objects stored in the DB management unit 100 on a sheet screen.

‘PRINT’ prints an idea wheel or an idea flat activated on a sheet screen.

‘UPLOAD’ uploads a Visual Basic Application (VBA) unit in connection with an internet site.

‘EXIT’ finishes a sheet screen.

These menus shown on a sheet screen may be modified or additional functions may be further added to the menus.

Seventh, an editing and managing function of an idea wheel or an idea flat will be described.

The editing and management unit 470 edits an entire sheet screen including an idea wheel or an idea flat, or data objects included in a home, wheels, sectors and cells, matches an image created in an idea flat to an idea wheel in a one-to-one correspondence, rotates an idea wheel or an idea flat, or has an idea wheel or an idea flat be edited.

As shown in FIG. 10, an activation window may be formed including UNDO, REDO, CUT, COPY, PASTE, DELETE, SELECT, SELECT ALL, WHEEL-FLAT MODIFY, WHEEL-ROTATE, and FIND/REPLACE.

WHEEL-FLAT MODIFY is a function of, as shown in FIG. 13, matching a home, wheels, sectors, rows and columns with each corresponding region of an idea flat to modify the same to an idea wheel or an idea flat by a UI.

WHEEL-ROTATE is a function of rotating a portion of or an entire idea wheel through a wheel rotating unit.

Eighth, a view managing function will be described.

The view managing function 480 sets a scheme and a window size of showing an activated idea wheel or idea flat on a sheet screen, extracts total slaves of a sector which includes a selected wheel in the same sector of an idea wheel or an idea flat to create the extracted total slaves on a new sheet screen or synthesizes the same with the existing idea wheel logical structure, and manages cell positions and data objects to be found.

The view managing function 480 includes, as shown in FIG. 11, menus of Add VIEW window, Unfold IW, View IW OUTLINE, View 3D IW (IDEA WHEEL), ACTUAL SIZE, ZOOM OUT, ZOOM IN, FIT PAGE, DRILL IN, DRILL OUT, FILTER, Position information, MEMO, Toolbox, Tack pane, and overall screen.

‘Add VIEW window’ activates plural idea wheels/flats on a sheet screen, amends all the activated windows simultaneously, only a corresponding window, or only a designated window.

‘Unfold IW’ modifies an activated idea wheel into an idea flat, and activates the idea flat on a sheet screen.

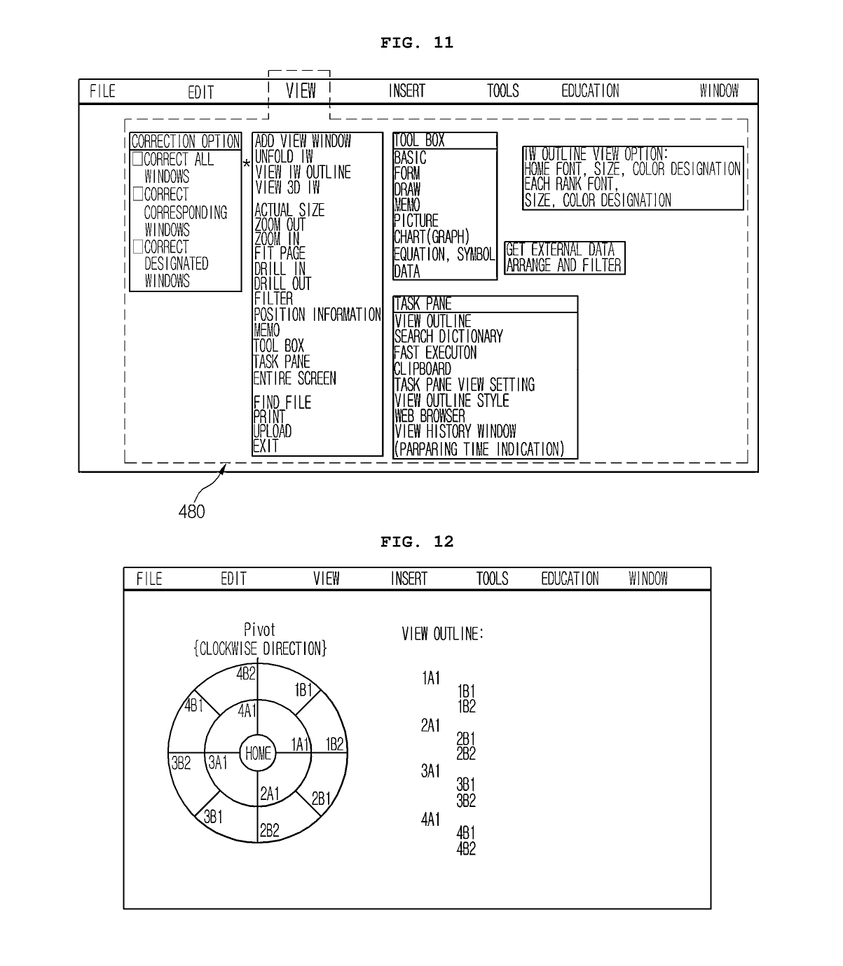

‘IW OUTLINE’, as shown in FIG. 12, extracts data objects included in a home, wheels, and sectors of plural activated idea wheels/flats on sheet screen, and makes a table in an up and down tree structure to activate the extracted data objects.

That is, data objects in the home (home portion) are set as a title, data objects in a first wheel around the home are set as an upper list, data objects in a second wheel around the home are set as a lower list, data objects in a third wheel around the home are set as the lowest list, and all the data objects are activated.

‘IW OUTLINE’ is a function of enabling interchange with the existing PowerPoint program and being used for presentation of a project progress or a result of research.

‘View 3D IW’ is a function of modifying an activated idea wheel/flat three-dimensionally and activating the same on a sheet screen.

‘ACTUAL SIZE’ is function of activating an idea wheel of an initially created size according to a counter value set in the idea wheel creating unit 210, or activating an idea flat of an initially created size according to a counter value set in the idea flat creating unit 220.

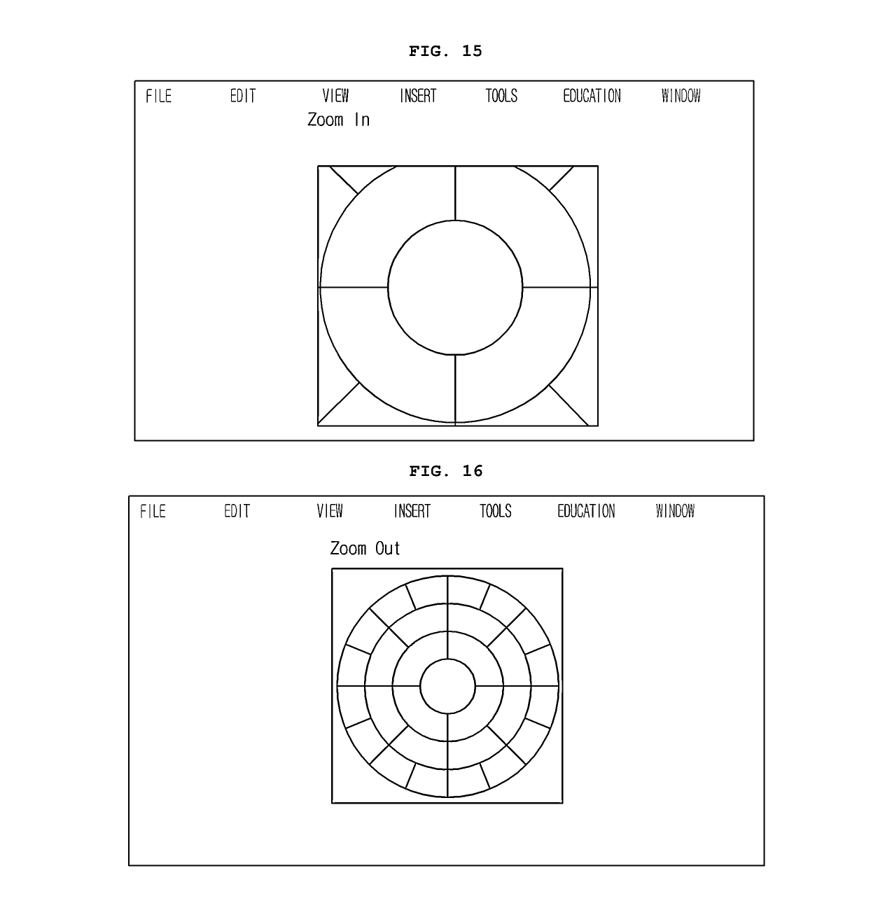

‘ZOOM OUT’ is a function of, as shown in FIG. 16, reducing an activated idea wheel/flat in a set proportion on a sheet screen.

‘ZOOM IN’ is a function of, as shown in FIG. 15, enlarging an activated idea wheel/flat in a set proportion on a sheet screen.

‘FIT PAGE’ is a function of activating an activated idea wheel/flat on a sheet screen to have a suitable size to the sheet screen.

‘DRILL IN’ is a function, as shown in FIG. 14, driven by a drill in function of the drill in/out unit 240, and of inserting a wheel extracted by a drill out operation, and slaves of a cell included in the extracted wheel into an idea wheel of a new sheet screen. In addition, this drill in operation may be implemented by a user's various gestures. For example, when a user selects a specific sector using two fingers to move the same (within an ideal wheel), a drill in function may be operated.

‘DRILL OUT’ is a function, as shown in FIG. 14, driven by a drill out function of the drill in/out unit 240, and of separating from an idea wheel a portion of region such as a specific sector, a specific wheel, or a specific column, that a user can select, and creates a new idea wheel.

‘FILTER’ is a function of arranging a specific wheel, sector or cell according to a reference value.

‘position information’ is a function of activating positions of a home, wheels, sectors and cells of an activated idea wheel or idea flat on a sheet screen.

‘MEMO’ is a function of activating a memo window enabling a user to make a memo to a home or cells of an activated idea wheel or idea flat on a sheet screen, and displaying the memo through the memo window.

‘toolbox’ is a function of causing data objects including a character form, drawing, a memo, a picture, a chart, an equation, or a symbol to access to a home, wheels, sectors or cells of an activated idea wheel or idea flat on a sheet screen.

‘task pane’ is a function of accessing to data objects included in a home, wheels, sectors, or cells of a current idea wheel or idea flat, extracts the data objects to display the same through a task pane including summary view, dictionary search, quick execution, clipboard, set view of task pane, style of summary view, web browser, and history window view (preparation time indication).

‘Overall screen’ is a function of activating an overall screen of a currently activated idea wheel or idea flat on a sheet screen.

Ninth, ideal wheel/flat insert managing function will be described.

The idea wheel insert management unit 490 may add/synthesize/delete files including a text or an image to/with/from data objects included in an idea wheel or an idea flat. In addition, the idea wheel insert management unit 490 may also insert, add, or delete wheels, sectors, and cells of an ideal wheel or an idea flat.

This, as shown in FIG. 18, may include an activation window including TEXT, LINKS, IMAGES, ATTACHMENT, CLIPART, CHARACTER TABLE, TEXT NOTE, AUDIO NOTE, CAPTURE, ADD SECTOR, ADD WHEEL, ADD COLUMN, INSERT IW, EXTRACT AS NEW IW, and INSERT SHEET.

Among these functions, ‘ADD SECTOR’ is a function of add sectors to an idea wheel or an idea flat to activate the same.

‘ADD WHEEL’ is a function of adding wheels to an idea wheel or an idea flat to activate the same.

‘ADD COLUMN’ is a function of adding columns to an idea wheel or an idea flat to activate the same.

‘INSERT IW’ is a function of inserting an idea wheel or an idea flat prepared in advance to an idea wheel or an idea flat.

‘EXTRACT AS NEW IW’ is the same function as the drill out, separating a specific region from an idea wheel or an idea flat to create a new idea wheel or idea flat.

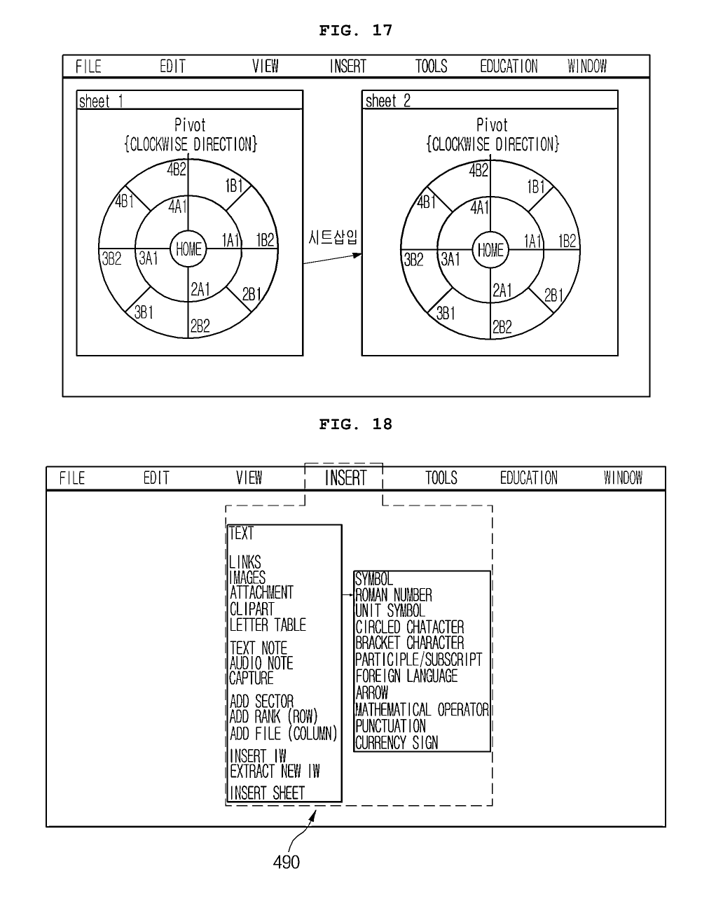

‘INSET SHEET’ is, as shown in FIG. 17, a function of inserting a sheet screen to another sheet screen.

Tenth, tool management function of an idea wheel or an idea flat.

The tool management unit 495 sets styles including character fonts, colors, 3D views, or emoticons of data objects included in a home, wheels, sectors or cells of an idea wheel or an idea flat, arranges wheels, sectors and cells of the idea wheel/ides flat, and manages the same by setting them as macros.

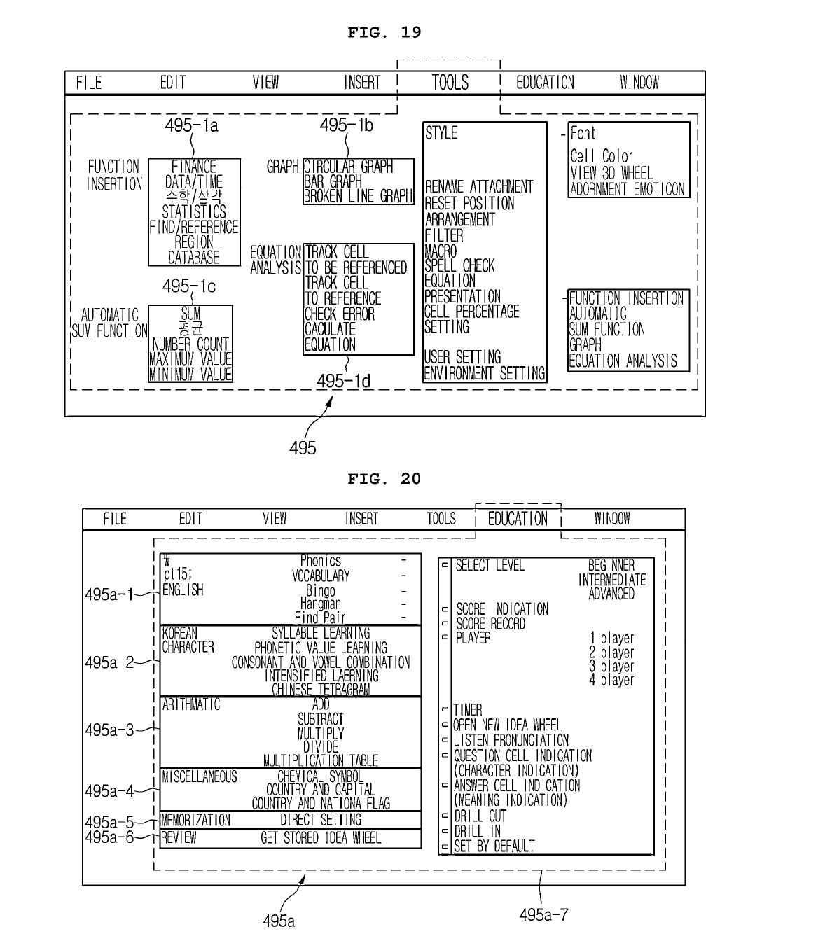

For example, as shown in FIG. 19, the tool management unit 495 may include an activation window including STYLE, RENAME ATTACHMENT, RESET POSITION, ARRANGE, FILTER, MACRO, SPELL CHECK, EQUATION, PRESENTATION, CELL PERCENTAGE SETTING, USER SETTING, and ENVIRONMENT SETTING.

‘STYLE’ is a function of activating character fonts and colors of stored data objects, and setting view of 3D wheel or adornment emoticons to activate the same.

‘RENAME ATTACHMENT’ is a function of changing a name of an attached file of a stored object.

‘RESET POSITION’ is a function of changing positions of a home, sectors, or cells of an idea wheel or an idea flat.

‘ARRANGE’ is a function of arranging a home, sectors or cells of an idea wheel, or an idea flat according to a reference value.

‘FILER’ is a function of arranging a home, sectors or cells of an idea wheel, or an idea flat by setting a specific home, a specific wheel, or a specific cell as a reference value.

‘MACRO’ is a function of setting macros to a home, sectors or cells of an idea wheel, or an idea flat.

‘SPELL CHECK’ is a function of checking spellings of words expressed in a home, sectors or cells of an idea wheel, or an idea flat.

‘EQUATION’ is a function of setting a function, an automatic sum, a graph, or an equation analysis to a home, sectors or cells of an idea wheel, or an idea flat.

For example, in order to implement functions similar to Excel, ‘EQUATION’ function may set a function insertion frame 495-1a, a graph activation frame 495-1b, an automatic sum frame 495-1c, or an equation analysis frame 49501b.

‘PRESENTATION’ is a function of converting an idea wheel or an idea flat into a presentation format.

‘CELL PERCENTAGE SETTING’ is a function of setting a percentage to cells of an idea wheel or an idea flat.

‘USER SETTING’ is a function of setting a discus type idea wheel or an up and down unfold type idea wheel to be created according to a size or colors desired by a user.

‘ENVIRONMENT SETTING’ is a function of setting an environment of automatic storing, making a backup file or a file stored position.

Eleventh, an educational managing function of an idea wheel or an idea flat will be described.

The educational managing function may be exemplified as an idea wheel or an idea flat of the embodiment which is used for educational software.

The education management unit 495a sets, for example, an English education mode, a Korean character education mode, an arithmetic education mode to stored data objects, and educates and manages a user to see at a glance, and to have operational thinking of a sequential discus type from a wheel having an origin to a wheel in a circumferential direction.

For example, a educational managing UI, as shown in FIG. 20, may be include an English education frame 495a-1, a Korean character education frame 495a-2, an arithmetic education frame 495a-3, other education frame 495a-4, a memorization frame 495a-5, a review frame 495a-6, and a basic menu frame for each subject 495a-7.

In addition, an idea wheel structure or an idea flat structure of the embodiment may also be implemented with entertainment game software, and be used as a game such as Bingo game.

For example, alphabet spellings are activated in a home, sectors and cells of an idea wheel or an idea flat, and then crossed to derive a spelling learning in a game form.

An entertainment game, Hangman may be also implemented. After a home, wheels, sectors, and cells of an idea wheel or an idea flat are activated, word learning may be derived to a game form in a way that guessing players alternately suggest a word until a correct word is obtained. For example, as shown in FIG. 29, associated words are designated for each section. And then a letter is suggested for each cell to guess a word by drawing a person within total 8 times in an order of head, body, left arm, right arm, left hand, right hand, left leg and right leg.

‘Find Pair’ interworks with an English dictionary stored in the DB management unit 100, activates English word cards in a home, wheels, sectors and cells of an idea wheel or an idea flat activated on a sheet screen, and the derives to find pair cards suitable for a theme, or a purpose.

Meanwhile, when this kind of software for education or an entertainment is implemented, an idea wheel or an idea flat may be used for memorization test as another example.

For example, a memorization frame 495a-5 interworks with an English-Korean dictionary stored in the DB management unit 100, creates learning templates of question and answer for English and Korean words in data objects included in a home, sectors, and cells of an idea wheel or an idea flat to activate the same.

This may be achieved, as shown in FIG. 27, in a way that contents desired to memorize are input to cells of a discus type idea wheel or an up and down unfold type idea wheel, with the cells divided into cells for question, and cells for answer, and then the cells are set by default.

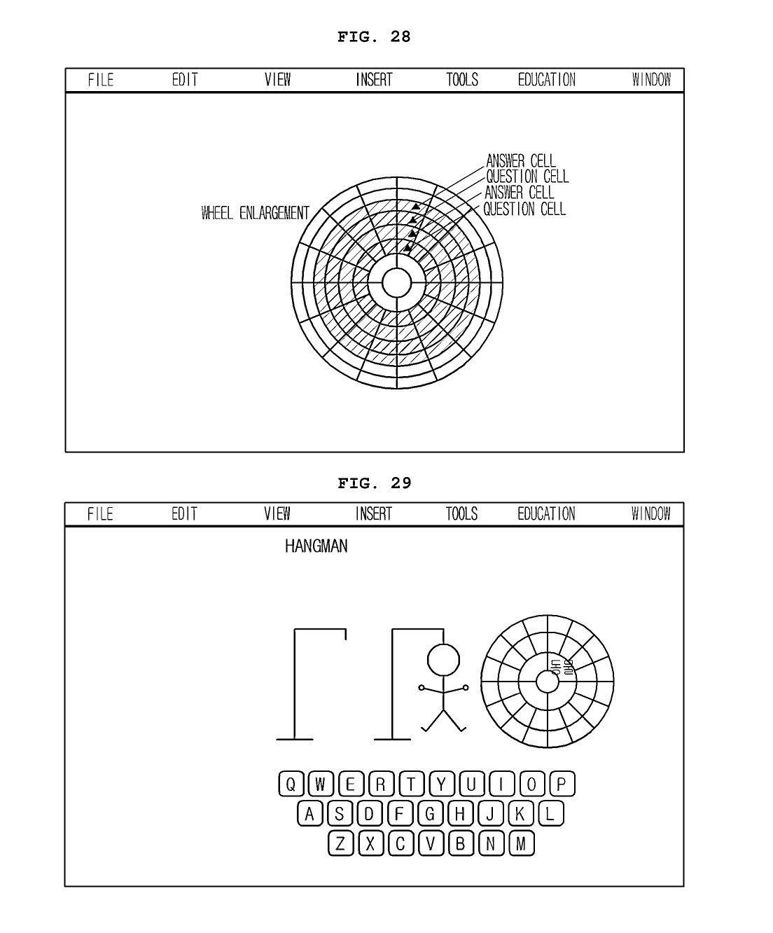

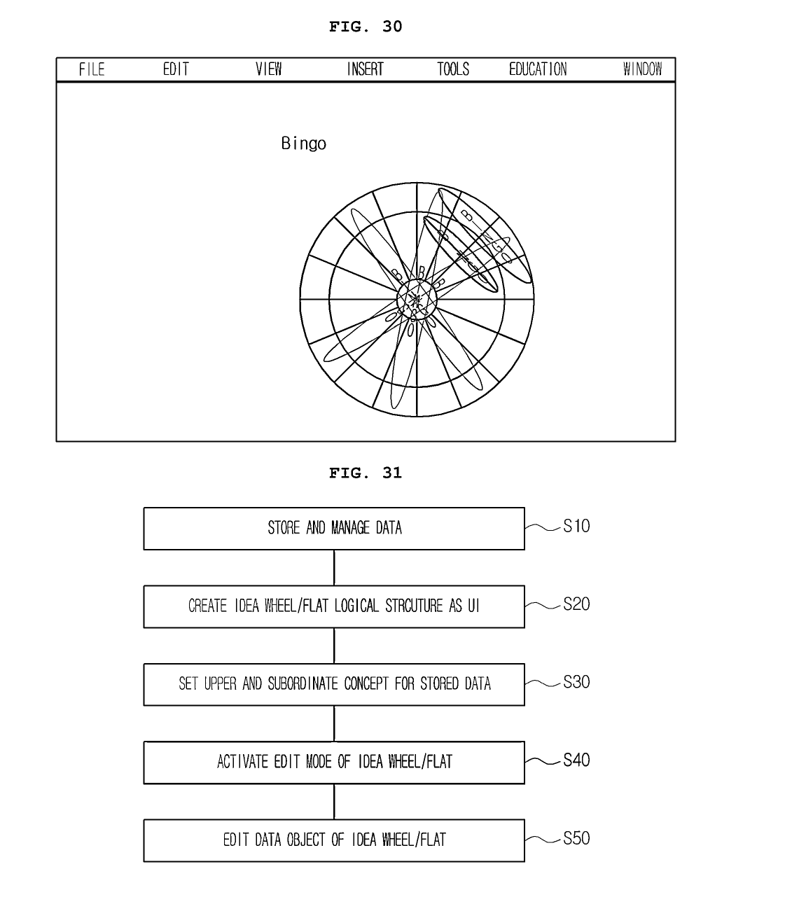

As shown in FIG. 28, the cells for question and the cells for answer may be changed with each other, and memorized by drilling out only a specific cell among the set cells for question and cells for answer through wheel enlargement, or performing open a new idea wheel.

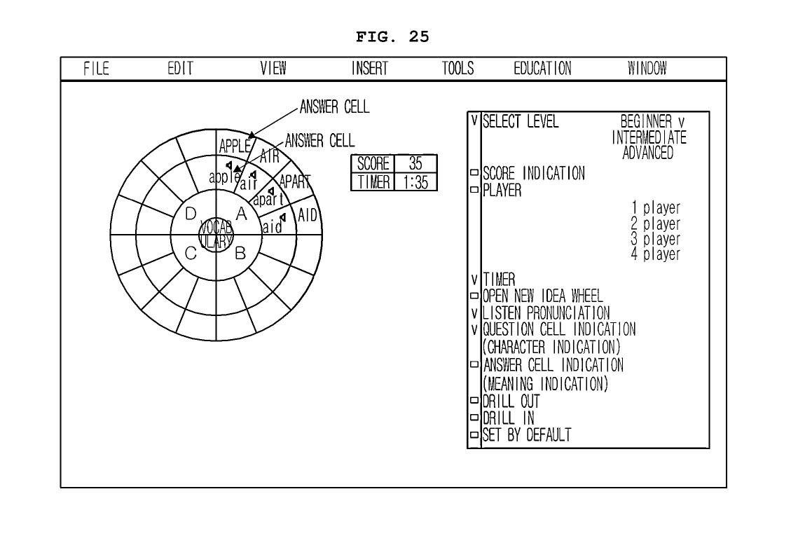

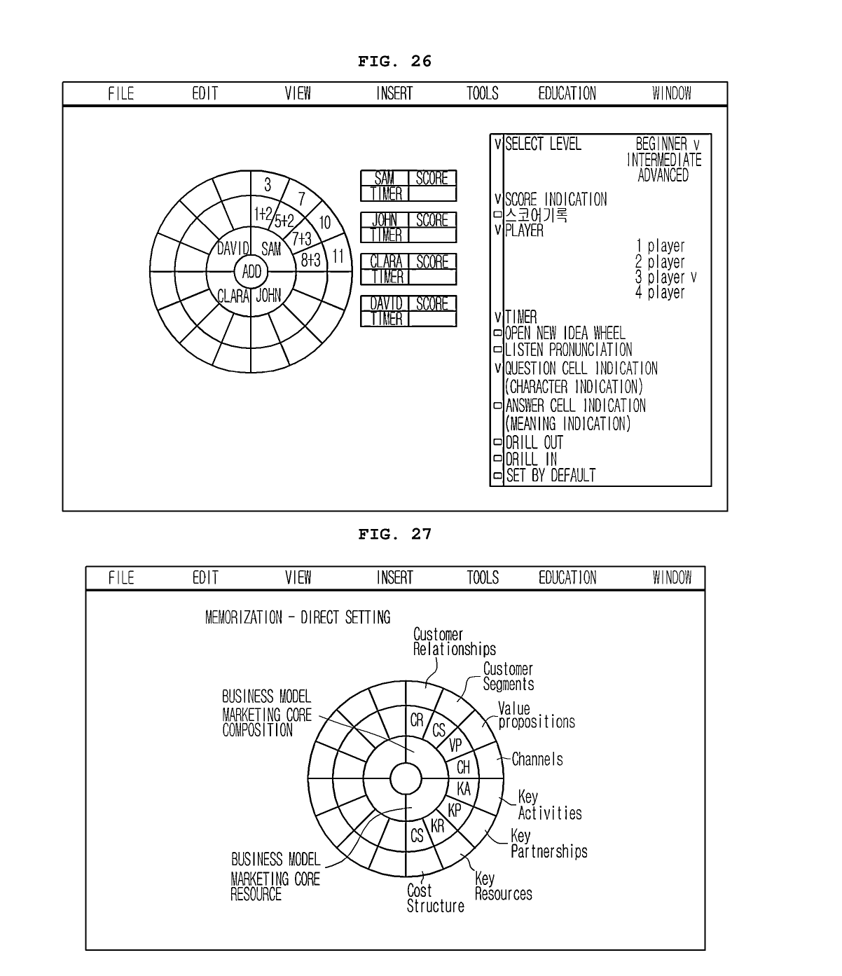

As other examples, as shown in FIGS. 25 and 26, a basic menu frame for each subject 495a-7 is indicated as a UI, and formed one side of the English education frame, the Korea character frame, the arithmetic frame, and other education frame. Then the basic menu frame for each subject 495a-7 may be used as an activation window by selecting any one of Select level for each education mode, Display score, Score record, Select player, Timer, Open new idea wheel, Listen pronunciation, Indicate cell for question, indicate cell for answer, Drill out for education, Drill in for education, and Set by default.

As this, due to a logical structure of an idea wheel or an idea flat of the embodiment, contents having various functions for entertainment or education may be manufactured. In this document, several examples are shown in the drawings.

Twelfth, a window managing function of an idea wheel or an idea flat will be described.

The window management unit 495b sets and manages arrangement of a sheet screen including an idea wheel or an idea flat.

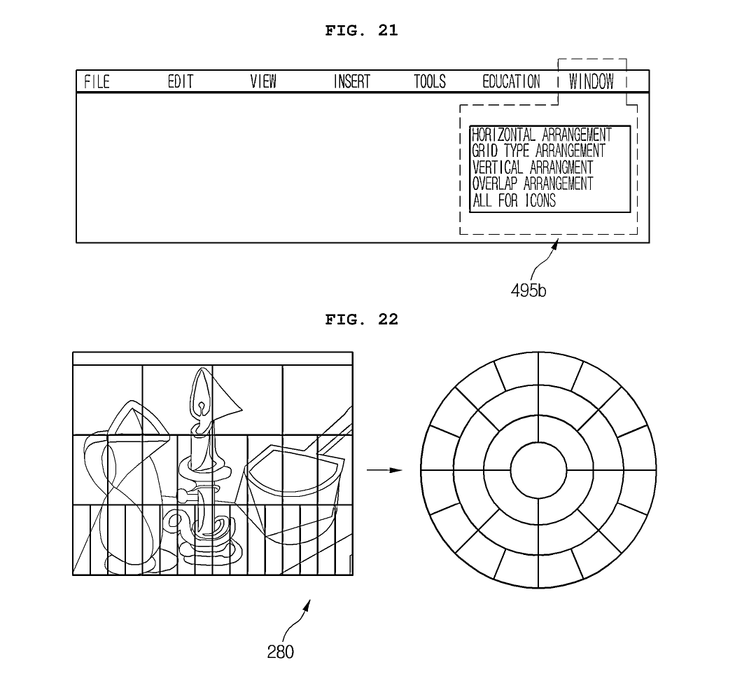

As shown in FIG. 21, the window management unit 495b may set various types of arrangement including Horizontal arrangement, Grid type arrangement, Vertical arrangement, Overlap arrangement, and Total icon indication.

‘Horizontal arrangement’ is a function of arranging an idea wheel or an idea flat horizontally.

‘Grid type arrangement’ is a function of arranging an idea wheel or an idea flat in a grid type.

‘Vertical arrangement’ is a function of arranging an idea wheel or an idea flat vertically.

‘Overlap arrangement’ is a function of arranging an idea wheel or an idea flat overlapped each other.

‘Total icon indication’ is a function of indicating all the stored data objects as icons.

Here, a method of creating and controlling data objects having an ideal wheel logical structure according to the embodiment will be described. Implementation of the idea wheel/the ideal flat is exemplified as access to/execution of data objects through an internet site or an application program.

First, as an operation of storing and managing data desired to be stored by a user, the DB management unit 100 stores and manages a program code which creates and edits an idea wheel logical structure, and data for a picture, a text, a video, or a file (operation S10).

In order to construct an idea wheel/an idea flat logical structure, a stored UI is displayed. In this operation, the program code and the data are read from the DB management unit 100 through the VBA unit, and an idea wheel logical structure is created as a UI under a control by the wheel controller 400 (operation S20).

Next, the stored data is set to be an upper concept and a lower concept. In this operation, the wheel controller 400 sequentially accesses data in the logical structure from a wheel including an origin to an outer wheel in a circumferential direction, and sets data included in the wheel having the origin as a master, and data included in the outer wheel in the circumferential direction as a slave (operation S30).

And then an operation of an edit mode of the idea wheel/the idea flat is performed. In this operation, when the idea wheel or the idea flat is activated by default under a control by the wheel controller 400, a File window, an Edit window, a View window, an Insert window, a Tools window, an Education window, and other windows may be activated under the control by the wheel controller 400 (operation S40).

Next, an operation of editing data objects stored in each region of the idea wheel or the idea flat is performed. In this operation, the data object management unit 420 is driven under a control by the wheel controller 400, and data objects in a sheet screen including a discus type idea wheel or an up and down unfold idea wheel are added, amended or deleted (operation S50).

Next, various functions such as driving of application programs including various games and education, or an internet connection through a hyperlink may be performed using data objects stored in each region (wheels, sectors and cells) of the idea wheel/the idea flat.

For example, the hyperlink controller 430 is driven under a control by the wheel controller 400, and the data objects in each of wheels, sectors and cells of an discus type idea wheel, and an up and down unfold idea wheel are accessed by setting up a hyperlink to the internet site and the application program.

The data object associating unit 440 is driven under a control by the wheel controller 400, specific data objects are read through the hyperlinked internet site and the application program to be stored in the DB management unit 100, and data objects stored in the DB management unit 100 is output to the internet site and the application program.

In addition, the smartphone associating unit is driven under a control by the wheel controller 400, an alarm, vibration or an SMS is output to a smartphone according to events set in the data objects.

Embodiments of the present disclosure may be implemented in a smartphone, a tablet PC, a desktop as an application program or software.

The present disclosure can continue to manage, control, and generate data, and forming data objects consistently.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for creating idea wheel-based data, the apparatus comprising:
a database (DB) management unit storing and managing data;
a Visual Basic Application (VBA) unit for reading the data stored in the DB management unit and creating as an idea wheel a user interface (UI) including a home as a reference position and wheels formed to surround the home;
a logical structure unit setting an X and Y coordinate for the idea wheel, dividing the idea wheel into sectors having the set X and Y coordinate as a reference, and arranging the data by a cell unit in each wheel included in the sector; and
a wheel controller controlling the idea wheel enabling a user to edit the idea wheel indicated by the UI for each sector, each wheel or each cell.

2. The apparatus according to claim 1, wherein the logical structure unit sets the reference position as an origin, and creates pivot regions for dividing the idea wheel into 4 regions using the X and Y coordinate having the origin as the reference.

3. The apparatus according to claim 2, wherein the logical structure unit sets a home region in each sector, at least one or more wheel regions surrounding the home region, and cell regions as a minimum unit storing the data.

4. The apparatus according to claim 3, wherein the wheel controller sets data stored in the home region as an upper object and data included in the wheel regions, which are away from the home region, as a subordinate object.

5. The apparatus according to claim 3, wherein the wheel controller creates a window enabling the user to create the UI of the idea wheel; and
the window comprises a menu enabling modification or editing of a circle type idea wheel structure into a sheet type idea flat whose upper side and lower side are distinguishable.

6. The apparatus according to claim 4, wherein the wheel controller indicates the sector regions or the wheel regions as a new idea wheel according to a user's selection or a user's gesture.

7. The apparatus according to claim 4, wherein the wheel controller adds and edits an idea wheel UI added by a user's selection or a user's gesture as wheel regions in the idea wheel.
